(19) United States
(12) Patent Application Publication
(10) Pub. No.: US 2023/0220772 A1
(43) Pub. Date: Jul. 13, 2023

(54) APPARATUSES, SYSTEMS, AND METHODS FOR DETECTING AND MONITORING A NATURAL GAS STREAM

(71) Applicant: Life Gauge LLC, Fostoria, MI (US)

(72) Inventor: Alan McDowell, Fostoria, MI (US)

(21) Appl. No.: 18/096,377

(22) Filed: Jan. 12, 2023

Related U.S. Application Data
(60) Provisional application No. 63/298,661, filed on Jan. 12, 2022.
(60) Provisional application No. 63/303,549, filed on Jan. 27, 2022.

(51) Int. Cl. E21B 49/08; G01N 31/22

(52) U.S. Cl. CPC E21B 49/0875; G01N 31/224

(57) ABSTRACT

Apparatuses, systems, and methods for detecting and monitoring hydrogen sulfide in a natural gas stream are disclosed herein. The apparatuses typically include a body comprising at least a first wall, a second wall spaced from the first wall, and a third wall coupled to the first wall and the second wall, wherein the first wall, the second wall, and the third wall define a chamber. The apparatus also typically includes an inlet conduit configured to receive a gaseous stream comprising natural gas and provide the gaseous stream to the chamber; a pressure valve coupled to the exit port, the pressure valve being configured to actuate to release an amount of gas; and an indicator at least partially disposed in the chamber, wherein the indicator comprises a reactive material that is adapted to produce a visual change in the presence of hydrogen sulfide.

### CROSS-REFERENCE TO RELATED APPLICATION

This application claims the benefit of priority from U.S. Provisional Application No. 63/298,661, filed on Jan. 12, 2022, and U.S. Provisional Application No. 63/303,549, filed on Jan. 27, 2022, the contents both of which are hereby incorporated herein in their entirety.

### FIELD OF THE DISCLOSURE

Aspects of the present disclosure relate to apparatuses, systems, and methods for detecting and monitoring hydrogen sulfide in a gaseous stream comprising natural gas.

### BACKGROUND OF THE DISCLOSURE

Natural gas reserves include hydrocarbon components such as methane (CH₄), ethane (C₂H₆), propane (C₃H₈), and butane (C₄H₁₀), and inorganics such as carbon dioxide (CO₂), hydrogen sulfide (H₂S), nitrogen (N₂), oxygen (O₂), and helium (He). The composition of the gas reserves varies with the source type. Associated gas reserves have lower concentrations of inorganic components, such as CO₂, H₂S, and N₂, than non-associated or shale gas reserves.

Traditionally, the gas composition is determined by sampling down-hole followed by surface laboratory analysis such as gas chromatography. Surface analysis is relatively expensive and slow, and sample integrity has to be ensured in storage. The number of samples that can be transported to the surface is also limited.

Several technologies have been proposed to carry out the downhole compositional analysis of gases. These include technologies are based on (near) infrared spectroscopy, mass spectroscopy, gas chromatography, nuclear magnetic resonance, or electrochemistry. The most successful of these technologies has been infrared absorption spectroscopy as deployed in the downhole fluid analyzer (DFA) tool of Schlumberger. However, the limitation of infrared spectroscopy is that the composition of homonuclear diatomic molecules, e.g., nitrogen, oxygen, hydrogen, and inert gases such as helium cannot be determined. These gases are substantially infrared inactive.

Additionally, the composition of natural gas can change as the natural gas reserve is depleted. Thus, individuals working on drill sites or with equipment and/or pipelines for processing of streams comprising natural gas may not be aware of the changes in the composition of the natural gas.

There is an ongoing need for apparatuses, systems, and methods for providing protection to individuals working with equipment and/or pipelines for processing natural gas from changes in the composition of the natural gas stream.

### BRIEF SUMMARY OF THE DISCLOSURE

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Aspects of the present disclosure are directed to apparatuses, systems, and methods for detecting and monitoring hydrogen sulfide in a natural gas stream. The inventors recognized that the composition of a natural gas stream may vary as the associated natural gas reserve is depleted over time. For instance, a natural gas stream may sour or have an increase in the concentration of hydrogen sulfide as the natural gas reserve is depleted. The inventors realized that the higher amount of hydrogen sulfide in the natural gas stream can pose a significant risk to the health of individuals that evaluate, fix, or otherwise work with the pipelines, pumps, gauges, valves, and other equipment used for extracting and processing the gaseous stream comprising natural gas.

Various embodiments of the present disclosure provide methods, systems, and apparatuses that advantageously enable an individual to quickly and easily determine if a stream comprising natural gas has a hydrogen sulfide concentration that may pose a health risk. In some preferable embodiments, the apparatuses and systems may be coupled or attached to other instruments or devices (e.g., a pressure gauge), such that an individual is able to determine that the hydrogen sulfide concentration is at a safe level in conjunction or simultaneously with determining the pressure within a pipeline, conduit, or equipment—thereby avoiding an additional task or step for the individual. By avoiding the inclusion of additional tasks or steps to determine if the concentration of hydrogen sulfide poses a health risk, certain embodiments of the disclosure improve the likelihood that individuals routinely determine that the hydrogen sulfide concentration is safe before completing tasks that could potentially expose such individual to the gaseous stream. It is believed that the methods, systems, and apparatuses disclosed herein may significantly reduce work related accidents resulting from undetected increases in hydrogen sulfide in a gaseous stream comprising natural gas.

In accordance with aspects of the disclosure, a method is provided for monitoring hydrogen sulfide in a gaseous stream. The method typically comprises obtaining a gaseous stream from a gas scrubber, the gaseous stream comprising natural gas; and providing a portion of the gaseous stream into an apparatus having a chamber. The apparatus comprising an indicator that is at least partially positioned in the chamber, wherein the indicator has a surface coated with a reactive material adapted to produce a visual change in the presence of hydrogen sulfide.

According to additional aspects of the disclosure, provided is an apparatus for detecting hydrogen sulfide in a gaseous stream. The apparatus typically includes a body comprising at least a first wall, a second wall spaced from the first wall, and a third wall coupled to the first wall and the second wall, wherein the first wall, the second wall, and the third wall define a chamber. The first wall and the second wall include a transparent material and the third wall defines an inlet port and an exit port. The apparatus also includes an inlet conduit coupled to the inlet port of the third wall. The inlet conduit may be configured to receive a gaseous stream comprising natural gas and provide the gaseous stream to the chamber. Additionally, the apparatus includes an indicator having a surface comprising a reactive material, where the indicator is coupled to the body such that at least a portion of the surface of the indicator is disposed in the chamber. The reactive material of the indicator is adapted to produce a visual change in the presence of hydrogen sulfide. A pressure valve is typically coupled to the exit port defined by the third wall, wherein the pressure valve is configured to actuate at a threshold pressure to release an amount of gas.

In accordance with certain aspects of the disclosure, a system is provided for detecting hydrogen sulfide in a gaseous stream. The system typically includes an apparatus, a feed conduit, and a solenoid valve. The apparatus includes a body comprising at least a first wall, a second wall spaced from the first wall, and a third wall coupled to the first wall and the second wall, wherein the first wall and the second wall comprise a transparent material, and wherein the third wall defines an inlet port and an exit port, and wherein the first wall, the second wall, and the third wall define a chamber. The apparatus also includes an inlet conduit coupled to the inlet port of the third wall, where the inlet conduit is configured to receive at least a portion of a gaseous stream comprising natural gas and to provide the gaseous stream to the chamber of the body. Additionally, the apparatus includes an indicator having a surface comprising a reactive material, the indicator coupled to the body of the apparatus, such that at least a portion of the surface of the indicator is positioned in the chamber. The reactive material of the indicator is adapted to produce a visual change in the presence of hydrogen sulfide. The apparatus has a pressure valve coupled to the exit port. The pressure valve is configured to actuate at a threshold pressure to release an amount of gas. The system includes a feed conduit that is in fluid communication with the inlet conduit. The feed conduit is configured to receive the gaseous stream and to provide at least a portion of the gaseous stream to the inlet conduit. The solenoid valve is typically in fluid communication with the inlet conduit. The solenoid valve is configured to periodically actuate to allow the at least a portion of the gaseous stream to be received by the inlet conduit.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 depicts a perspective view of a non-limiting example of a system for detecting hydrogen sulfide in accordance with aspects of the disclosure;

FIG. 2 is an exploded view of the system of FIG. 1;

FIG. 3 depicts a front view of the system of FIG. 1;

FIGS. 4A and 4B depict a side views of the system of FIG. 1;

FIG. 5 depicts a rear view of the system of FIG. 1;

FIG. 6 depicts a bottom view of the system of FIG. 1;

FIG. 7 depicts a top view of the system of FIG. 1;

FIG. 8 depicts a perspective view of the system of FIG. 1 with the indicator and holder removed from the system;

FIGS. 9A and 9B are a perspective and front view of a controller according to aspects of the disclosure;

FIG. 9C is a schematic showing the coupling of a solar panel, one or more batteries, a controller, and an apparatus in accordance with aspects of the disclosure; and

FIG. 10 is a flow chart of a non-limiting example of a method for monitoring hydrogen sulfide according to aspects of the disclosure.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

References to one or an embodiment in the present disclosure can be, but not necessarily are, references to the same embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized means “including, but not necessarily limited to”; it specifically indicates open-ended inclusion or membership in the so-described combination, group, series and the like. The term “a” means “one or more” unless the context clearly indicates a single element. The term “about” when used in connection with a numerical value means a variation consistent with the range of error in equipment used to measure the values, for which ±5% may be expected. “First,” “second,” etc., re labels to distinguish components or blocks of otherwise similar names, but does not imply any sequence or numerical limitation. When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

Aspects of the present disclosure are directed to apparatuses, systems, and methods for detecting and monitoring hydrogen sulfide in gaseous stream comprising natural gas. As noted above, various embodiments of the present disclosure provide methods, systems, and apparatuses that advantageously enable an individual to quickly and easily determine if a stream comprising natural gas has a hydrogen sulfide concentration that may pose a health risk. In some preferable embodiments, the apparatuses and systems may be coupled or attached to other instruments or devices (e.g., a pressure gauge), such that an individual is able to determine that the hydrogen sulfide concentration is at a safe level in conjunction or simultaneously with determining the pressure within a pipeline, conduit, or equipment. It is believed that the methods, systems, and apparatuses disclosed herein may significantly reduce work related accidents resulting from undetected increases in hydrogen sulfide in a gaseous stream comprising natural gas.

According to an aspect of the disclosure, provided is an apparatus 100 for detecting and/or monitoring hydrogen sulfide in a gaseous stream (e.g., a natural gas stream). As a general overview, apparatus 100 typically comprises a body 110 defining a chamber, an inlet conduit 130, an indicator 140 having a reactive material adapted to produce a visual change in the presence of hydrogen sulfide, and a pressure valve 150 for releasing an amount of gas at certain pressures.

Apparatus 100 includes a body having at least a first wall 112, a second wall 114 that is spaced from first wall 112, and a third wall 116 that is coupled to first wall 112 and second wall 114. Body 110 of apparatus 100 has a chamber typically defined by first wall 112, second wall 114, and third wall 116.

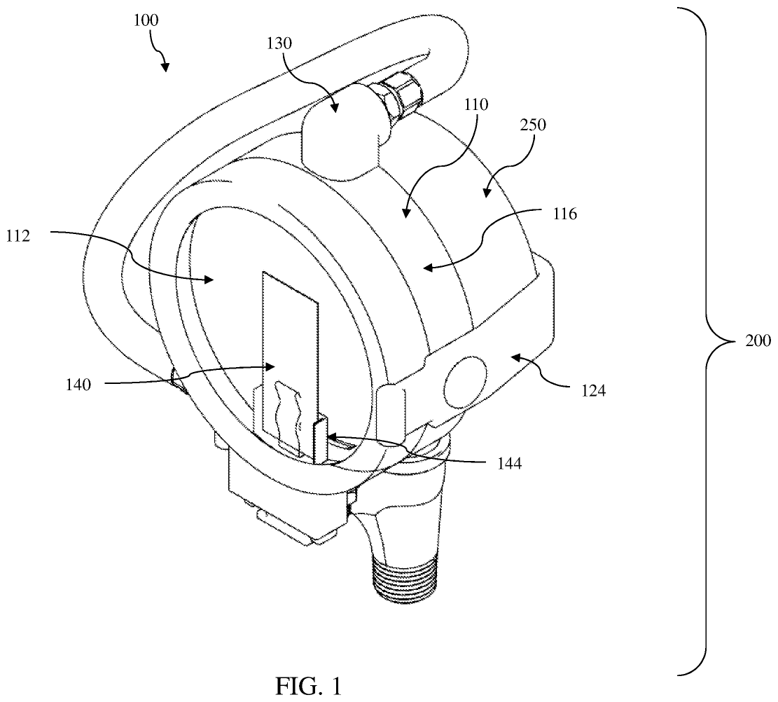

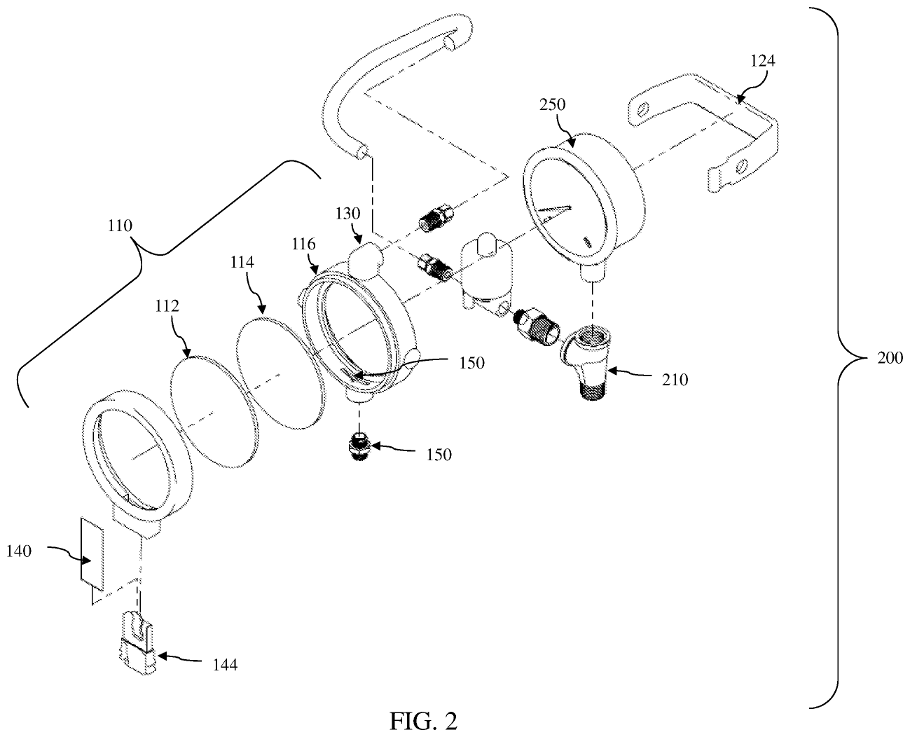

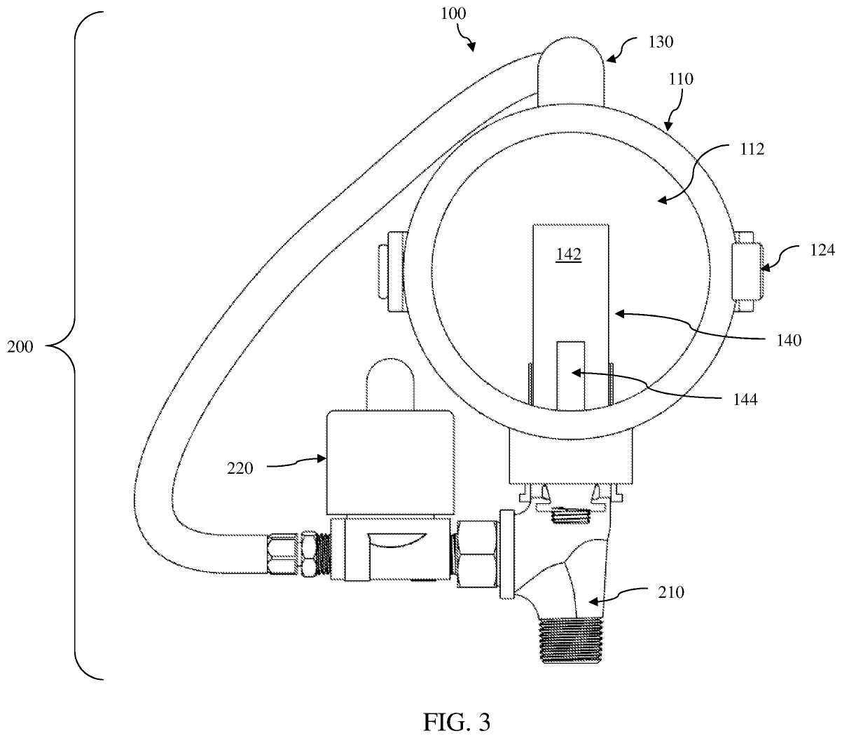

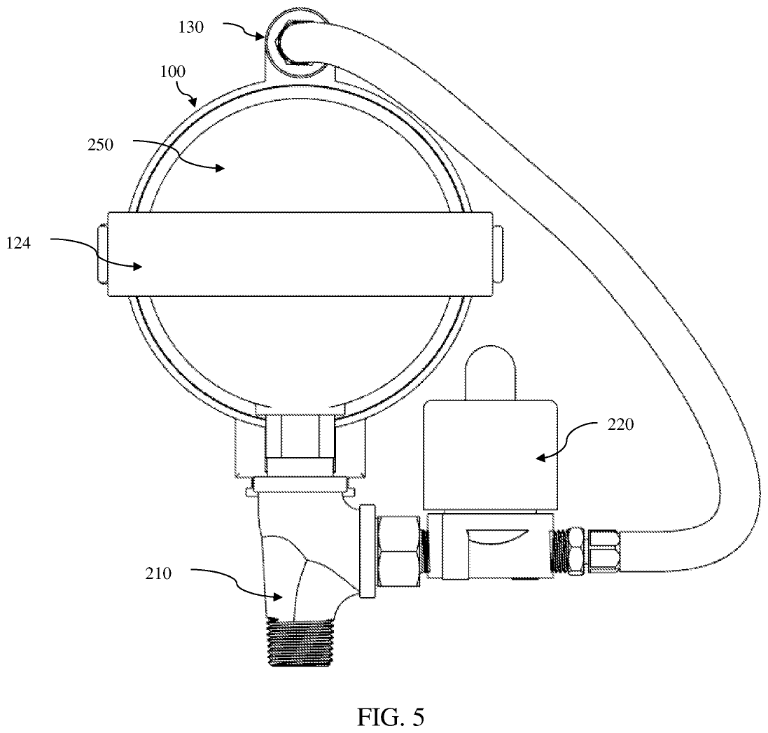

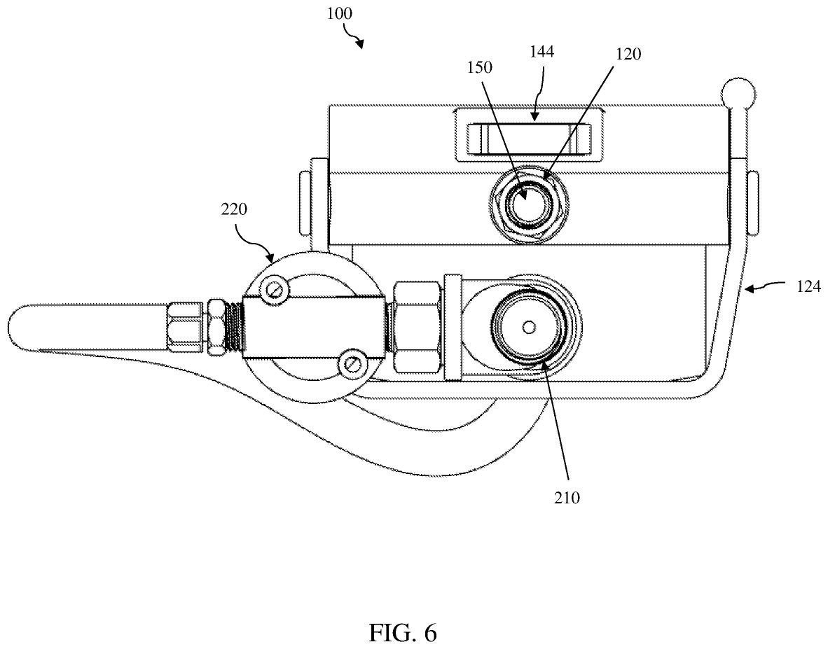

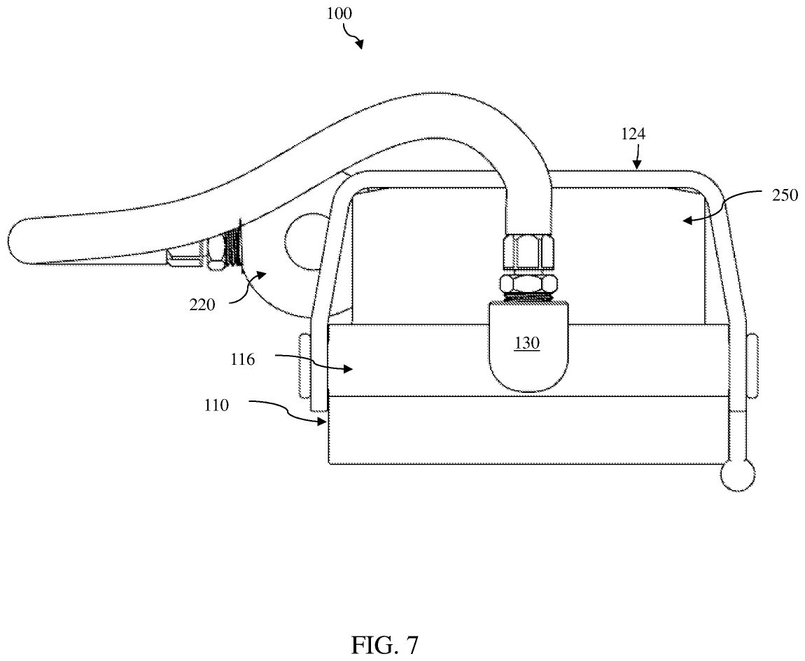

As seen in FIGS. 1-7, first wall 112 and second wall 114 comprise a transparent material. For example, first wall 112 and second wall 114 may consist of or be completely formed from a transparent material. The transparent material may be glass, such as a tempered glass, or a polymer, such as polycarbonate, poly(methyl methacrylate), polyethylene terephthalate, amorphous copolyester, polyvinyl chloride, or the like. In some cases, the transparent material may be a portion of the first wall 112 and/or second wall 114. For example, the transparent material may form a window in first wall 112 and/or second wall 114. Additionally and/or alternatively, first wall 112 and/or second wall 114 may be circular or another geometric or non-geometric shape. In other words, the outer perimeter of first wall 112 and/or second wall 114 may form a circle, a square, a rectangle, a hexagon, octagon, or a non-geometric shape.

Third wall 116 may extend from first wall 112 and attach to second wall 114. Although third wall 116 may be directly attached to both the first wall 112 and the second wall 114, in some cases third wall 116 may extend from one of first wall 112 and second wall 114 and directly attach to a fourth wall extending from the other of first wall 112 and second wall 114. Third wall 116 may be circumferential or may have a geometric shape, such as a square, rectangle, hexagon, octagon, or the like, or may have a non-geometric shape. Generally, third wall 116 has a shape that corresponds the outer perimeter of first wall 112 and/or second wall 114. Third wall 116 typically has an inlet port and an exit port 120. Preferably, third wall 116 includes a slot 122 that is configured for receiving an indicator 140 and/or an indicator holder 142. The third wall may comprise or be formed of a transparent material and/or may comprise an opaque material.

Apparatus 100 includes an indicator 140 coupled to body 110, such that at least a portion of a surface 142 of indicator 140 is positioned in the chamber. For example, indicator 140 may be configured to be inserted through slot 122, such that at least a portion of indicator 140 is positioned in the chamber. In some embodiments, at least 10%, at least 30%, at least 50%, at least 60%, at least 70%, at least 80%, or at least 90% of indicator 140 is disposed in the chamber defined by body 110. In at least one embodiment, all of indicator 140 is disposed in the chamber defined by body 110. In certain embodiments, apparatus 100 and indicator 140 are configured such that about 10 to about 90% of the indicator is disposed in the chamber defined by body 110. For example, the apparatus 100 and indicator 140 are configured such that from about 10 to about 80%, about 10 to about 70%, about 10 to about 60%, about 10 to about 50%, about 10 to about 40%; from about 20 to about 80%, about 20 to about 70%, about 20 to about 60%, about 20 to about 50%, about 20 to about 40%; from about 30 to about 80%, about 30 to about 70%, about 30 to about 60%, about 30 to about 50%, about 30 to about 40%; from about 40 to about 80%, about 40 to about 70%, about 40 to about 60%, about 40 to about 50%; from about 50 to about 80%, about 50 to about 70%, about 50 to about 60%; from about 60 to about 80%, about 60 to about 70%, or about 70 to 80%, including any range or subrange therebetween, of indicator 140 is disposed in the chamber defined by body 110.

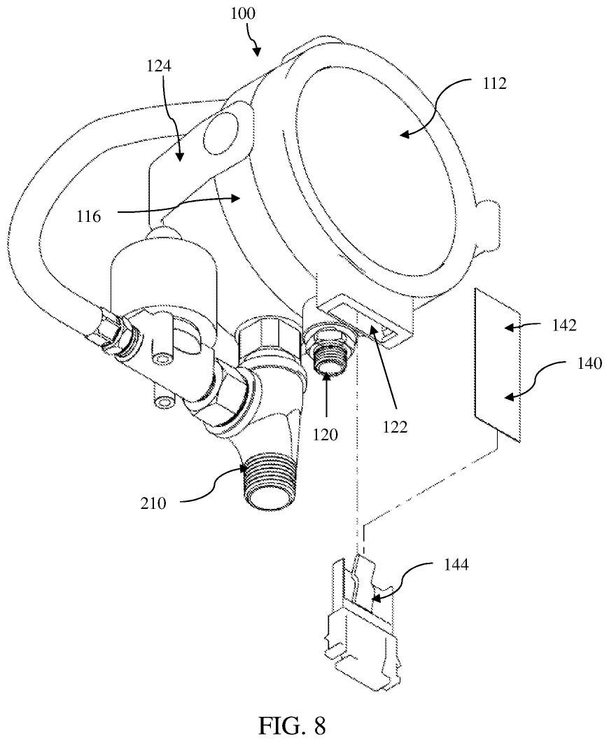

Indicator 140 may be attached to a holder 144, as shown in FIG. 8. Holder 144 may be attached to indicator 140 by way of any suitable mechanical means (e.g., crimping of the holder, a rivet, a biasing means, a protrusion to produce pressure and/or friction, etc.) or chemical means (e.g., glue). Preferably, holder 144 has a contacting surface configured to contact a surface of third wall 116 to stop the insertion of holder 144 into slot 122 and to position indicator 140 in the chamber. For example, the contract surface may be a surface of a protrusion (e.g., lip, ledge, or bump) that is configured to contact third wall 116 to prevent further insertion of indicator 140 and/or holder 144. In some embodiments, the contact surface may directly contact third wall 116 to prevent further insertion of indicator 140 and/or holder 144. In further embodiments, a sealing element may be positioned between the contact surface and third wall 116 to prevent further insertion of indicator 140 and/or holder 144. The sealing element may be an O-ring or a rubber gasket.

Additionally or alternatively, holder 144 and slot 122 form a seal therebetween when indicator 140 is inserted into slot 122 until the contacting surface of holder 144 contacts a surface of third wall 116. For example, an outer surface of holder 144 may contact an inner surface of slot 122 to form a seal between holder 144 and slot 122 of third wall 116. Holder 144 may attach and/or couple to third wall 116 when indicator 140 is inserted into slot 122 until the contacting surface of holder 144 contacts a surface of third wall 116. Holder 144 may attach and/or couple to third wall 116 by way of a clip, fastener, strap, etc.

The inner surface of slot 122 may have a friction coefficient when in contact with indicator 140 and/or holder 144 that is greater than the friction coefficient of the material comprising third wall 116 when in contact with indicator 140 and/or holder 144. The friction constant of the inner surface of slot 122 when in contact with indicator 140 and/or holder 144 may, in some instances, be about 0.2 to about 2. For example, certain embodiments of apparatus 100 may have a friction coefficient of the inner surface of slot 122 when in contact with indicator 140 and/or holder 144 of from about 0.2 to about 2, about 0.2 to about 1.6, about 0.2 to about 1.2, about 0.2 to about 1, about 0.2 to about 0.9, about 0.2 to about 0.8, about 0.2 to about 0.7, about 0.2 to about 0.6, about 0.2 to about 0.5, about 0.2 to about 0.4; from about 0.3 to about 2, about 0.3 to about 1.6, about 0.3 to about 1.2, about 0.3 to about 1, about 0.3 to about 0.9, about 0.3 to about 0.8, about 0.3 to about 0.7, about 0.3 to about 0.6, about 0.3 to about 0.5; from about 0.4 to about 2, about 0.4 to about 1.6, about 0.4 to about 1.2, about 0.4 to about 1, about 0.4 to about 0.9, about 0.4 to about 0.8, about 0.4 to about 0.7, about 0.4 to about 0.6; from about 0.5 to about 2, about 0.5 to about 1.6, about 0.5 to about 1.2, about 0.5 to about 1, about 0.5 to about 0.9, about 0.5 to about 0.8, about 0.5 to about 0.7; from about 0.7 to about 2, about 0.7 to about 1.6, about 0.7 to about 1.2, about 0.7 to about 1, about 0.7 to about 0.9; from about 0.9 to about 2, about 0.9 to about 1.6, about 0.9 to about 1.2, about 0.9 to about 1; from about 1.1 to about 2, about 1.1 to about 1.6, about 1.1 to about 1.2; from about 1.4 to about 2, about 1.4 to about 1.6, or about 1.7 to about 2, or any arrange or subrange thereof. Additionally or alternatively, the inner surface of slot 122 may comprise or be formed of a compressible material. In certain embodiments, the inner surface of slot 122 may comprise or be formed of a material having a compressibility that is greater than the compressibility of the material of indicator 140 and/or holder 144.

Indicator 140 typically comprises a reactive material adapted to produce a visual change in the presence of hydrogen sulfide. As used herein, a visual change is referred to a change that is visible with the naked eye by an individual, e.g., having 20/20 vision with or without corrective eyewear. When the visual change is a change in color, the color change is visible with the naked eye. Indicator 140 may have a surface 142 comprising the reactive material. In some embodiments, the reactive material is coated on indicator 140, while in other embodiments a section of indicator 140 comprises the reactive material. Preferably, the reactive material reacts with hydrogen sulfide in the gaseous state. The reactive material may comprise sodium and iron. In some embodiments, the reactive material consists of sodium and iron. In further embodiments, the reactive material comprises NaₓFe_{y}, wherein x is any integer from 1 to 6 or from 1 to 3 (e.g., 1, 2, 3, 4, 5, or 6) and y is any integer from 1 to 3 (e.g., 1, 2, or 3). Additionally or alternatively, the reactive material may comprise 2-amino-5-N,N-diethylaminotoluene and Fe(III) ions; lead acetate; cadmium sulphide; and non-fluorescent amines. Non-limiting examples of reactive material that may be suitable for certain embodiments of the disclosure are disclosed in U.S. Pat. No. 6,939,717, which is incorporated herein in its entirety for all purposes.

The reactive material may produce a visual change in the presence of a gaseous composition (e.g., natural gas) having a concentration of hydrogen sulfide of 0.25 ppm or more. In some cases, the reactive material may produce the visual change in the presence of a gas composition having a concentration of hydrogen sulfide of about 0.1 ppm or more, about 0.15 ppm or more, about 0.2 ppm or more, about 0.25 ppm or more. The visual change of the reactive material may be a change in color of the reactive material. In one instance, the reactive material undergoes a color change to the color brown in the presence of a threshold concentration of hydrogen sulfide. The reactive material may produce a visual change that is proportional to the concentration of hydrogen sulfide in the gaseous stream. In some embodiments, however, the reactive material does not produce a visual change that is proportional to the concentration of hydrogen sulfide in the gas composition. Instead, in some embodiments, the reactive material has a first visual appearance indicating that the concentration of hydrogen sulfide is below a threshold concentration and has a second visual appearance indicating that the concentration of hydrogen sulfide is above a threshold concentration.

Apparatus 100 and/or indicator 140 may be configured such that the visual change occurs when indicator 140 is in the presence of a gaseous composition having a concentration of a hydrogen sulfide of above a threshold level (such as 0.25 ppm) within about 180 seconds. In some preferred embodiments, the visual change occurs in the presence of a gaseous composition having a concentration of a hydrogen sulfide of above one of the foregoing threshold levels in 180 seconds or less, about 120 seconds or less, about 100 seconds or less, about 80 seconds or less, about 60 seconds or less, about 50 seconds or less, about 40 seconds or less, about 30 seconds or less, about 20 seconds or less, about 15 seconds or less, about 10 seconds or less, about 7 seconds or less, about 5 seconds or less, about 3 seconds or less, about 2 seconds or less, about 1 seconds or less, about 0.5 seconds or less.

Apparatus 100 includes inlet conduit 130 that is in fluidic communication with inlet port of third wall 116. As illustrated in the embodiment shown in FIG. 1, inlet conduit 130 is coupled to inlet port. Inlet conduit 130 is configured to receive a gaseous stream comprising natural gas and provide the gaseous stream to the chamber.

A pressure valve 150 is typically coupled to exit port 120 of third wall 116. Pressure valve 150 is configured to actuate at a threshold pressure to release an amount of gas. In some embodiments, the pressure valve is configured to actuate at a pressure of about 1.1 atm or more, about 1.2 atm or more, about 1.35 atm or more, about 1.5 atm or more, about 1.65 atm or more, about 1.8 atm or more, or about 2 atm or more.

Apparatus 100 is generally configured to be coupled to an instrument or device. Although apparatus 100 is illustrated in FIGS. 1-8 as being coupled to a pressure gauge, certain embodiments of apparatus 100 may be configured for coupling to an instrument or device for displaying temperature, specific gravity, density, electrical power, etc. Body 110 of apparatus 100 may have fasteners 124 for attaching to an edge or protrusion on an instrument or device. Fasteners 124 may be clips, latches, snaps, or other mechanical fastening features. In some cases, apparatus 100 may include one or more straps configured for attaching to an instrument or device. Additionally, body 110 may include one or more edges dimensioned to correspond to an edge on the front of a pressure gauge, e.g., to align apparatus 100 and/or the chamber with the face of the pressure gauge. The one or more edges may extend from second wall 114 and/or third wall 116. Body 110 may include a section of compressible material for contacting the instrument or device. The section of compressible material, when compressed, may produces a bias against the instrument or device, thereby securing apparatus 100 to the instrument or device after the fasteners 124 and/or the straps are attached to the instrument or device.

Preferably, apparatus 100 is configured such that attachment of apparatus 100 to an instrument or device positions second wall 114 adjacent to the display of the instrument or device. For instance, attachment of apparatus 100 to an instrument or device may align first wall 112, second wall 114, and the chamber therebetween, such that the display of the instrument or device (e.g., face of a pressure gauge) is visible through the transparent material of the first wall 112, the chamber, and the transparent material of the second wall 114.

Apparatus 100 may be configured such that at least a portion of indicator 140 is visible in the chamber. Indicator 140 may extend radially through third wall 116 and into the chamber defined by body 110 to be visible in the chamber through first wall 112 and/or second wall 114. In some embodiments, apparatus 100 is configured such that when the contacting surface stops insertion of indicator 140, indicator 140 extends up to the center or approximately to the center of the chamber defined by body 110. For example, apparatus 100 and indicator 140 may be configured such that when the contacting surface stops insertion of indicator 140, indicator 140 extends to the center or within about 35% of the center of the chamber, where the percentage is based on the distance between the distal end of indicator 140 and the center of the chamber relative to the diameter and/or length of the chamber in the direction of extension of indicator 140. In some embodiments, indicator 140 may extend within about 35%, within about 30%, within about 25%, within about 20%, within about 15%, within about 10%, within about 5%, or within about 1%, of the center of the chamber, where the percentage is based on the distance between the distal end of indicator 140 and the center of the chamber relative to the diameter and/or length of the chamber in the direction of extension of indicator 140. The distal end of indicator 140 typically refers to the end of indicator 140 that is closest to the center of the chamber, while the proximal end of indicator 140 may refer to the end of indicator 140 closest to third wall 116.

Advantageously, in preferred embodiments, an individual can view at least a portion of indicator 140 and determine if hydrogen sulfide is above a threshold concentration simultaneously or in conjunction with viewing the display of the instrument or device. In some instances, slot 122 extends through third wall 116 at a location such that when apparatus 100 is coupled to the instrument or device, indicator 140 extends from a bottom portion of the chamber to the center portion of the chamber. As used herein, the bottom portion of the chamber or body 110 refers to the portion of the chamber or body 110 proximal to an individual attempting to view and assess the display of the instrument or device when apparatus 100 is attached to such instrument or device (e.g., when the face of such instrument or device is horizontal or parallel to the ground). When the face of such instrument or device is vertical or perpendicular to the floor, the bottom portion may refer to portion of the chamber or body 110 proximal to the ground. By positioning indicator 140 to extend from the bottom portion of the chamber to the center portion of the chamber, indicator 140 may avoid obstructing and/or inhibiting the view of the numbers or hand of the display of the instrument or device.

Indicator 140 may extend from third wall 116 (e.g., in a radial direction) to have a length L disposed in the chamber that is about 10% to about 60% of the diameter of the chamber. In some embodiments, length L of indicator 140 disposed in the chamber is about 20% to about 60%, about 30% to about 60%, about 40% to about 60%, about 20% to about 50%, about 30% to about 50%, about 40% to about 50%; about 10% to about 40%, about 10% to about 30%, or about 10% to about 20% of the diameter of the chamber. Although slot 122 and indicator 140 may be configured such that at least a portion of indicator 140 extends from third wall 116 in a radial direction toward a center of chamber, in some embodiments indicator 140 may extend at an angle relative to the radial direction into the chamber. For example, indicator 140 to extend from third wall 116 at an angle relative to the radial direction of about 10° to about 55°, about 10° to about 45°, or about 10° to about 35°. Apparatus 100 may be configured to comply with IEC 61511.

In accordance with yet a further aspect of the disclosure, a system 200 is provide for detecting and/or monitoring hydrogen sulfide. As a general overview, system 200 comprises: an apparatus having a body 110 defining a chamber, an inlet conduit 130, an indicator 140 having a reactive material adapted to produce a visual change in the presence of hydrogen sulfide, and a pressure valve 150; a feed conduit 210; and a solenoid valve 220. System 200 typically employs an apparatus similar to apparatus 100. Thus, for brevity, system 200 will be discussed with reference to one or more features of apparatus 100.

System 200 typically includes a feed conduit 210 in fluid communication with the inlet conduit 130 of apparatus 100. Feed conduit 210 may be configured to receive a gaseous stream comprising natural gas and provide at least a portion of the gaseous stream to inlet conduit 130. Feed conduit 210 may be configured to provide at least a portion of the gaseous stream to one or more instruments or devices (such as a pressure gauge) in addition to apparatus 100. As illustrated in FIG. 1, feed conduit 210 may comprise a T-pipe connector. In some embodiments, feed conduit 210 is in fluid communication with a gas scrubber, such that feed conduit 210 receives a gaseous output stream from the gas scrubber.

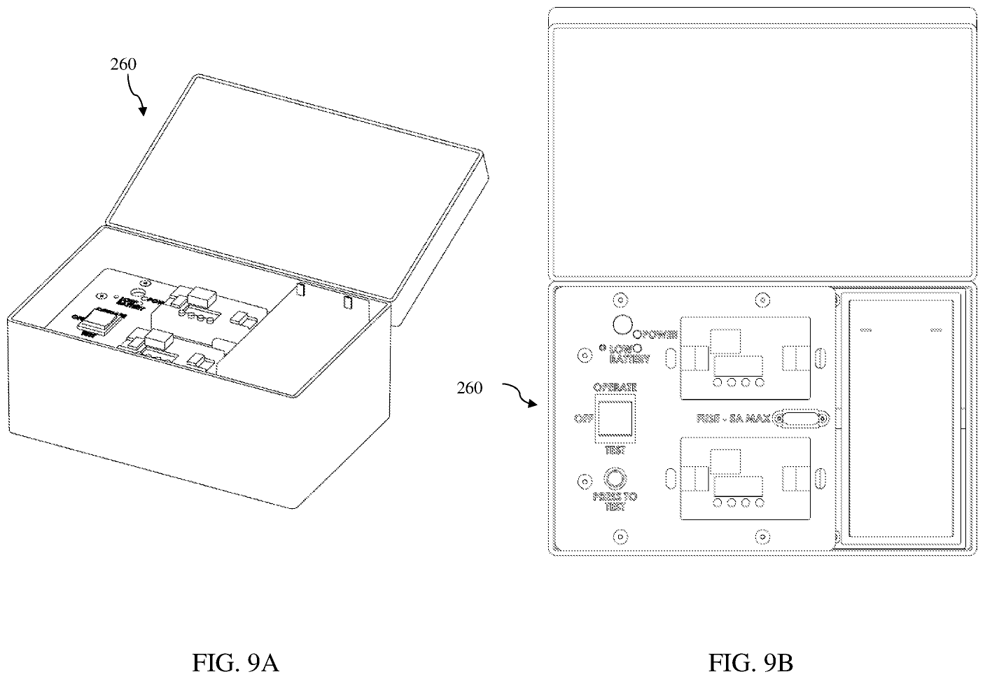

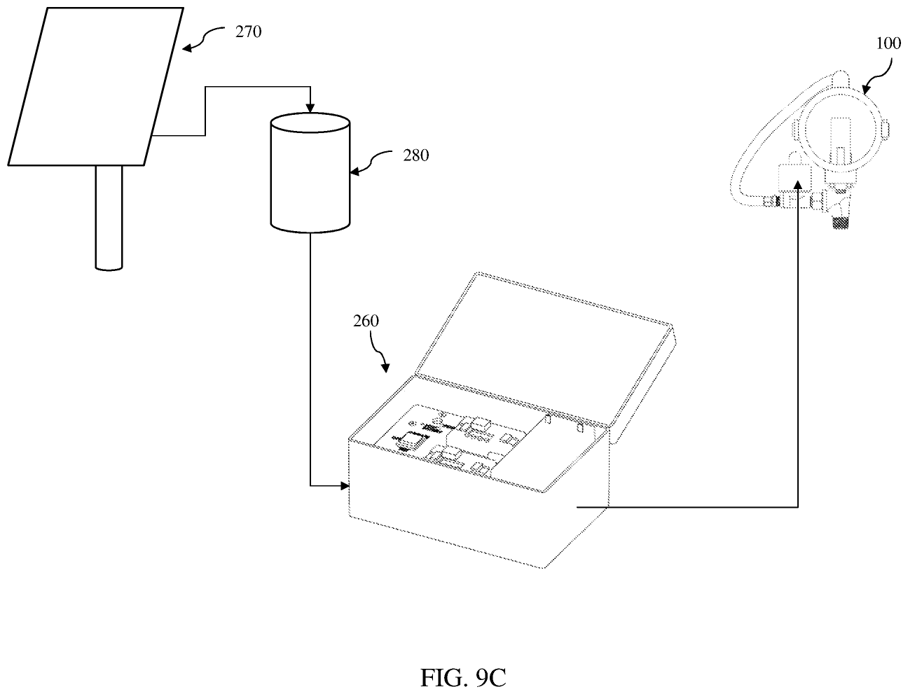

Solenoid valve 220 of system 200 is typically in fluid communication with inlet conduit 130. Solenoid valve 220 may be directly coupled to inlet conduit 130 or may be directly coupled to feed conduit 210 to be in fluid communication with inlet conduit 130 via feed conduit 210. Solenoid valve 220 is also typically coupled to a controller 260 (see FIG. 9). Controller 260 may be configured to periodically actuate solenoid valve 220 to allow at least a portion of the gaseous stream to be received by inlet conduit 130. For example, controller 260 may be configured to actuate solenoid valve 220 at least 2 times a day. In some cases, controller 260 is configured to actuate solenoid valve 220 at least 6 times a day, at least 12 times a day, at least 24 times a day (e.g., every hour), at least 48 times a day (e.g., every 30 minutes), etc. Additionally or alternatively, controller 260 may actuate solenoid valve 220 in real-time, e.g., in response to a prompt from an individual. For example, an individual may be able to actuate solenoid valve 220 (e.g., via controller 260) to ensure that the gaseous stream does not have a hydrogen sulfide concentration above a threshold level in real time. Non-limiting examples of solenoid valves 220 include high performance solenoid valves, high pressure solenoid valves, pneumatic solenoid valves, solenoid gas valves, solenoid air valves, or the like.

As seen in FIG. 9C, system 200 may optionally include one or more batteries 280 and/or solar panels 270. The one or more batteries 280 and/or solar panels 270 may be electrically coupled to power controller 260 and/or solenoid valve 220. In some embodiments, the solar panels 270 may charge the one or more batteries 280. In further embodiments, system 200 is configured such that the one or more batteries 280 are capable of powering solenoid valve 220 for one or more months, three or more months, six or more months, nine or more months, one or more years, three or more years, or five or more years. In some embodiments, solenoid valve 220 is the only feature of system 200 that uses electricity.

System 200 may include a pressure gauge 250 configured to determine the pressure of the gaseous stream. Pressure gauge 250 may have a face for displaying a pressure. Pressure gauge 250 is typically in fluid communication with feed conduit 210 and is configured to receive a portion of a gaseous stream. Examples of pressure gauges 250 that may be employed in system 200 include, but are not limited to, absolute pressure gauge, differential (dp) pressure gauge, bellows pressure gauge, bourdon tube pressure gauge, diaphragm pressure gauge, and capsule pressure gauge.

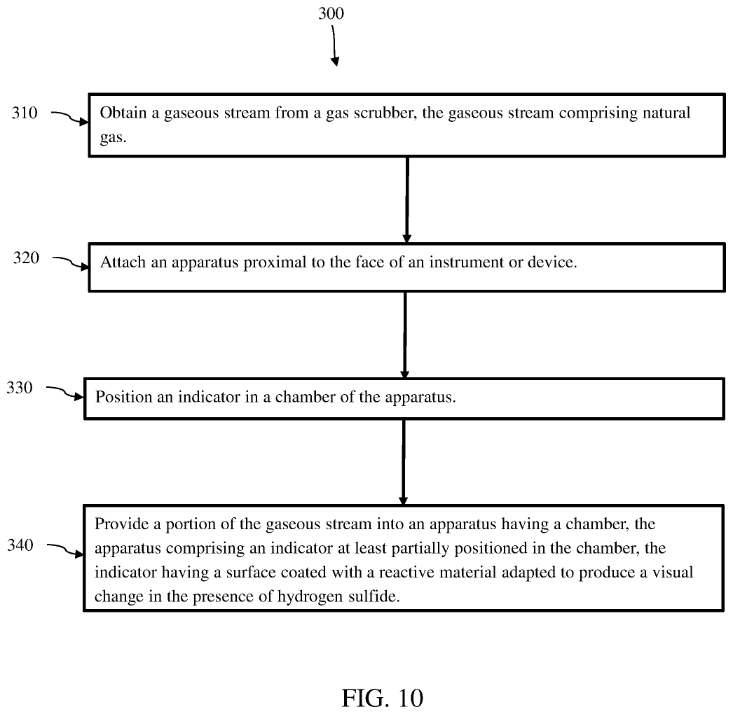

In accordance with one aspect of the disclosure, a method 300 is provided for monitoring hydrogen sulfide in a gaseous stream. Referring to FIG. 10, method 300 generally includes obtaining a gaseous stream from a gas scrubber in step 310; and providing a portion of the gaseous stream into an apparatus having a chamber, wherein an indicator is at least partially positioned in the chamber and the indicator has a reactive material adapted to produce a visual change in the presence of hydrogen sulfide. Method 300 may employ one or more apparatuses or systems for detecting and/or monitoring hydrogen sulfide in a gaseous stream. For example, method 300 may employ one or more systems 200 and/or apparatuses 100. Thus, for brevity, method 300 will be discussed with reference to one or more features of system 200 and/or apparatus 100.

In step 310, a gaseous stream is obtained from a gas scrubber. The gaseous stream typically comprises natural gas. Preferably, the amount of water vapor in the gaseous stream obtained from the gas scrubber is less than about 1 vol. %, less than about 0.5 vol. %, less than about 0.1 vol. %, or less than about 0.05 vol. %, based on the total volume of the gaseous stream. The gaseous stream may be obtained directly from a wellhead at a drill site. For example, method 300 may include obtaining a gaseous stream directly from a wellhead, providing the gaseous stream to a scrubber, and obtaining a gaseous output stream from the scrubber in order to provide the gaseous output stream to a system to detect hydrogen sulfide therein.

In some embodiments, method 300 further includes attaching an apparatus (e.g., apparatus 100) proximal to the face of an instrument or device (see step 320). In one embodiment, the apparatus is attached to a pressure gauge, such that the apparatus is proximal to the front or face of the pressure gauge. Preferably, the apparatus has at least one wall adjacent to the front or face of the instrument or device when the apparatus is attached to such instrument or device. The apparatus may be attached to the pressure gauge by way of mechanical means, such as fasteners, clips, latches, straps, threads, welding, etc., or by chemical means, such as glue. Additionally or alternatively, the apparatus may be fluidically coupled to the same port as the instrument or device for receiving the gaseous stream. By fluidically coupling the apparatus to the same inlet port for receiving a portion of the gaseous stream as the instrument or device, advantageous method 300 does not include adding new ports to the pipelines or conduits containing the gaseous stream.

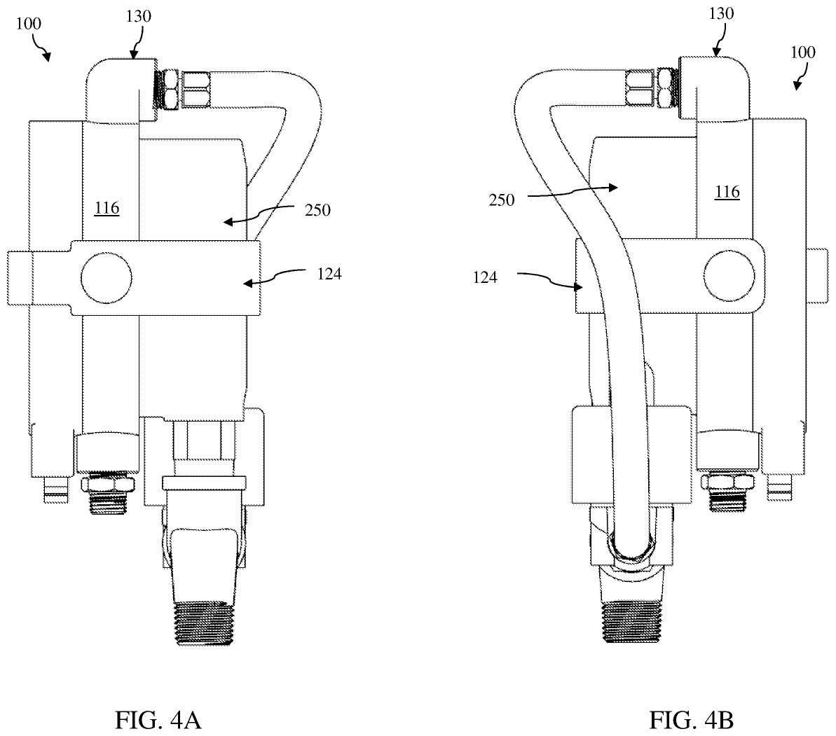

Method 300 may include positioning an indicator (e.g., indicator 140) in a chamber of the apparatus (e.g., apparatus 100), as seen in step 330 of FIG. 4. The indicator may be positioned to be at least partially disposed within the chamber of the apparatus by inserting the indicator through a slot defined by a wall of the apparatus. In some embodiments, the indicator may be positioned to extend from the portion of the wall defining the slot up to the center of the chamber.

In step 340, a portion of the gaseous stream is provided to an apparatus having a chamber. For instance, the gaseous stream may be provided to a feed conduit (e.g., feed conduit 210), which is in fluid communication with the chamber of the apparatus (e.g., apparatus 100). In some embodiments, the feed conduit is in fluid communication with an instrument or device (e.g., a pressure gauge) for monitoring one or more parameters of the gaseous stream, such that the feed conduit provides a portion of the gaseous stream to the apparatus having the chamber and a portion of the gaseous stream to the instrument or device. The feed conduit may be in fluidic communication with the chamber by way of an inlet conduit (e.g., inlet conduit 130). The indicator may have a surface comprising or coated with a reactive material adapted to produce a visual change in the presence of hydrogen sulfide. In some embodiments, the reactive material reacts with hydrogen sulfide in the gaseous state.

Although the invention is illustrated and described herein with reference to specific embodiments, the invention is not intended to be limited to the details shown. Rather, various modifications may be made in the details within the scope and range of equivalents of the claims and without departing from the invention.

1. A method for monitoring hydrogen sulfide in a gaseous stream, the method comprising:
obtaining a gaseous stream from a gas scrubber, the gaseous stream comprising natural gas; and
providing a portion of the gaseous stream into an apparatus having a chamber, the apparatus comprising an indicator at least partially positioned in the chamber, the indicator having a surface coated with a reactive material adapted to produce a visual change in the presence of hydrogen sulfide.

2. The method of claim 1 further comprising: attaching the apparatus proximal to the face of a pressure gauge, such that the chamber of the apparatus aligns with the face of the pressure gauge.

3. The method of claim 1, wherein the gas scrubber has an input stream comprising natural gas, the input stream being obtained from a wellhead.

4. The method of claim 1, wherein the reactive material is adapted to produce the visual change by reacting with hydrogen sulfide.

5. The method of claim 4, wherein the reactive material is adapted to react with hydrogen sulfide in a gaseous state and wherein the visual change of the reactive material comprises a color change.

6. (canceled)

7. The method of claim 1, wherein the indicator is adapted to produce the visual change when the gaseous stream has a concentration of hydrogen sulfide of 0.25 ppm or more.

8. (canceled)

9. The method of claim 1, wherein the reactive material of the indicator comprises sodium and iron.

10. The method of claim 9, wherein the reactive material of the indicator comprises NaₓFe_{y}.

11. An apparatus for detecting hydrogen sulfide comprising:
a body comprising at least a first wall, a second wall spaced from the first wall, and a third wall coupled to the first wall and the second wall, wherein the first wall and the second wall comprise a transparent material, and wherein the third wall defines an inlet port and an exit port, and wherein the first wall, the second wall, and the third wall define a chamber;
an inlet conduit coupled to the inlet port of the third wall, the inlet conduit configured to receive a gaseous stream comprising natural gas and provide the gaseous stream to the chamber;
an indicator having a surface comprising a reactive material, the indicator coupled to the body such that at least a portion of the surface of the indicator is disposed in the chamber, wherein the reactive material is adapted to produce a visual change in the presence of hydrogen sulfide; and
a pressure valve coupled to the exit port, the pressure valve being configured to actuate at a threshold pressure to release an amount of gas.

12. The apparatus of claim 11, wherein the body is configured to be attached to a pressure gauge, such that the second wall of the body is adjacent to a face of the pressure gauge.

13. (canceled)

14. The apparatus of claim 11, wherein the third wall extends from the first wall to the second wall, wherein at least one of the first wall and the second wall are circular and wherein the third wall is circumferential.

15. (canceled)

16. (canceled)

17. The apparatus of claim 11, wherein the indicator is attached to a holder, and wherein the third wall further comprises a slot extending therethrough, the slot being configured to receive at least a portion of the indicator and the holder, wherein the holder and the slot form a seal therebetween when the holder is inserted into the slot.

18-20. (canceled)

21. The apparatus of claim 11, wherein the pressure valve actuates at the threshold pressure of 1.5 atm.

22. (canceled)

23. A system for detecting hydrogen sulfide comprising:
(a) an apparatus, the apparatus comprising:
a body comprising at least a first wall, a second wall spaced from the first wall, and a third wall coupled to the first wall and the second wall, wherein the first wall and the second wall comprise a transparent material, and wherein the third wall defines an inlet port and an exit port, and wherein the first wall, the second wall, and the third wall define a chamber,
an inlet conduit coupled to the inlet port of the third wall, the inlet conduit configured to receive at least a portion of a gaseous stream comprising natural gas and to provide the gaseous stream to the chamber of the body,
an indicator having a surface comprising a reactive material, the indicator coupled to the body such that at least a portion of the surface of the indicator is positioned in the chamber, wherein the reactive material is adapted to produce a visual change in the presence of hydrogen sulfide, and
a pressure valve coupled to the exit port, the pressure valve being configured to actuate at a threshold pressure to release an amount of gas;
(b) a feed conduit in fluid communication with the inlet conduit, the feed conduit configured to receive the gaseous stream and to provide at least a portion of the gaseous stream to the inlet conduit; and
(c) a solenoid valve in fluid communication with the inlet conduit, the solenoid valve configured to periodically actuate to allow the at least a portion of the gaseous stream to be received by the inlet conduit.

24. The system of claim 23 further comprising:
(d) a pressure gauge configured to determine the pressure of the gaseous stream and having a face for displaying the determined pressure, wherein the pressure gauge is in fluid communication with the feed conduit and is configured to receive a portion of the gaseous stream wherein the apparatus is coupled to the pressure gauge, such that one of the first wall or the second wall of the apparatus is adjacent to the face of the pressure gauge.

25. (canceled)

26. The system of claim 24, wherein the indicator is attached to a holder, and wherein the third wall further comprises a slot extending therethrough, the slot being configured to receive at least a portion of the indicator.

27. The system of claim 26, wherein at least one of the holder and the slot has a contacting surface for stopping insertion of the indicator into the chamber, wherein when the contacting surface stops insertion of the indicator, the indicator extends up to the center of the chamber.

28. (canceled)

29. The system of claim 27, wherein the slot extends through the third wall at a bottom portion of the chamber, such that the indicator extends from a bottom portion of the chamber to the center of the chamber.

30. The system of claim 23, wherein the reactive material is adapted to produce a visual change by reacting with hydrogen sulfide.

31. The system of claim 23, wherein the visual change of the reactive material comprises a color change, and wherein the indicator is adapted to produce the visual change in the presence of hydrogen sulfide at a concentration of 0.25 ppm or more.

32-36. (canceled)
